(19) United States
(12) Patent Application Publication
(10) Pub. No.: US 2008/0126978 A1
(43) Pub. Date: May 29, 2008

(54) System and method of enhancing computer security by using dual desktop technologies

(76) Inventors: Likun Bai, Toronto (CA); Wen Jie Huang, Pingba (CN)

Correspondence Address: Likun Bai, 3275 Sheppard Ave E, Apt. 1414, Toronto, ON, M1T 3P1, omitted

(21) Appl. No.: 11/701,487

(22) Filed: Feb. 2, 2007

Related U.S. Application Data
(60) Provisional application No. 60/861,255, filed on Nov. 28, 2006.

(51) Int. Cl. G06F 3/048

(52) U.S. Cl. 715/778

(57) ABSTRACT

A system and method of enhancing a computer sysem secuirty provides dual desktops for one user on one computer. One desktop is assigned low privileges and is used to handle potential risky tasks.

This nonprovisional application claims the benefit of U.S. Provisional Application No. 60/861,255, filed Nov. 28, 2006. The contents of the provisional application are hereby incorporated by reference.

### BACKGROUND OF THE INVENTION

This invention is related to enhancing computer security. Nowadays, there are many computer viruses, worms, and spy softwares spreading through networks, such as the Internet. There are many solutions for this problem.

A common solution is to set up different user accounts on a computer. Each account is assigned certain privileges defining what operations can be performed through this account. This is a very effective way to protect a computer.

A drawback of the implementation of the above solution is that a computer with a graphic user interface, like Windows systems and Linux systems, only creates one desktop for each user account and allows one user account to be logged in at a time. A user has to log off an account in order to switch to another account. It's not convenient. In Linux or Unix systems and Windows Vista, whenever higher account privileges are required, a user has to input a password for higher privilege accounts to continue operating. Inputting a password very often is not a pleasant thing to do.

A better solution is needed.

To protect a computer, another concept is to isolate the computer system from viruses, worms, etc. There are some related inventions.

The U.S. Pat. No. 6,578,140 issued to Policard. Policard discloses a computer has two systems, one is a master system, the other one is an internet system. A KVM switch is used to switch between the two systems. This invention has some difficulties to fit in with existing systems. It requires two computer systems to implement.

U.S Patent application #20040111578, inventors are Goodman, Reginald A. Copeland, and Scott Russell. This invention discloses that two operating systems are installed in one computer. The second operating system handles potential risky tasks. This invention requires that a computer runs two operating systems and exchanging data and operations has to be done between two systems. It is not convenient.

We need a better solution which can use the user account privileges concept easily and isolate a computer system from potential risky environments.

### SUMMARY OF THE INVENTION

The invention discloses an enhanced computer system which comprises one computer including an operating system, a monitor (terminal), etc and some software programs. The computer creates two desktops by adding a second additional dedsktop on its monitor for a user. One desktop is assigned low privileges and is used to handle potential risky tasks, such as browsing the web and sending/receiving e-mail; The other desktop is used to handle administrating and other safe tasks, such as installing a new software, changing system settings, running Word processor, Excel, photo shops, playing games, developing software, etc.

A user can access these two desktops simultaneously.

### BRIEF DESCRIPTION OF THE DRAWINGS

FIG. 1 shows a flow chart of the process of creating two desktops.

FIG. 2 shows a flow chart of the process of creating two desktops after the logging in process.

FIG. 3 shows a typical computer with two desktops.

FIG. 4 shows a second desktop is created by using one of remote desktop technologies on one computer.

FIG. 5 shows a second desktop is created by using one of remote desktop technologies combining with a virtual machine technology on one computer.

FIG. 6 shows a second desktop is created by using one of remote desktop technologies in a network environment.

FIG. 7 shows the Internet Service Server running a different Operating System from the computer.

FIG. 8 shows one Internet Service Server serves more than one computer.

### DETAILED DESCRIPTION OF THE INVENTION

A desktop is a graphic user interface associated with some operation privileges. It is not an ordinary graphic interface which merely interacts with a user. A desktop sets some limits on its user interacting operations according to its privileges. It prohibits a user to perform some operations.

One way to create a second additional desktop is to run a software program having a graphic user interface which has been assigned some privileges. All user interacting operations through this user interface will be checked according to the assigned privileges, only those operations which are allowed by the privileges will be performed.

Another way to create a second additional desktop is to let one user account have two user account interfaces (desktops). That is to produce two user account interfaces (desktops) for one user account. It seems as if there are two user accounts are logged in on one monitor simultaneously. One user account interface (desktop) has low privileges and is used to handle potential risky tasks.

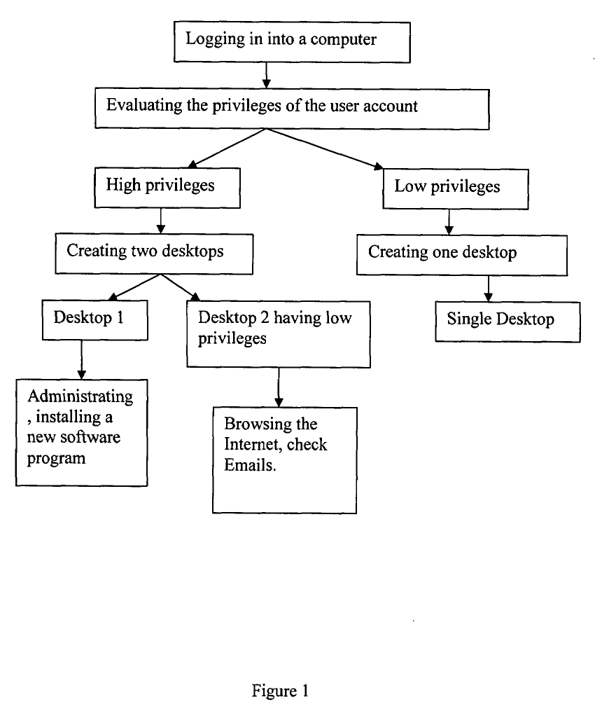

In FIG. 1, a flow chart of creating two desktops is shown. It starts from a user account being used to log in into a computer system. The computer system evaluates the privileges of the user account. If the privileges is high, the computer system will create two desktops on its monitor. One of these two desktops is assigned with low privileges and is used to handle potential risky tasks, such as browsing the web and sending/receiving e-mail. The other desktop is used to handle administrating and other safe tasks, such as installing a new software, changing system settings, running Word processor, Excel, photo shops, playing games, developing software, etc.

Users can access both desktops simultineously.

If a low privilege account is logged in, such as a guest account, the computer system only produces one desktop to be used to handle potential risky and non-administrating tasks.

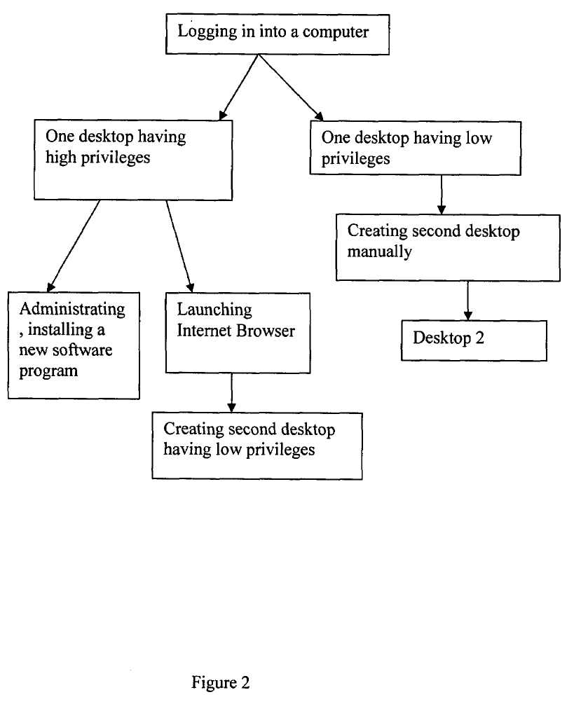

In FIG. 2, another creating two desktops flow chart is shown. The privilege evaluation process is not involved in order to speed up the logging in process, thus, only one desktop is created after logging in process. If a high privilege account is used to log in, a second desktop can be created automatically by openning a software program which is used to handle potential risky tasks, such as the Internet Explorer. After the second desktop is created, the potential risky tasks will be handled through the second desktop. A second desktop also can be created by clicking an shortcut icon of a software program which is capable of creating a second desktop.

If a low privilege account is used to log in, the second desktop can be created manually by launching a software and providing proper logging in information. A second desktop always can be created manually no matter what user account is used to log in.

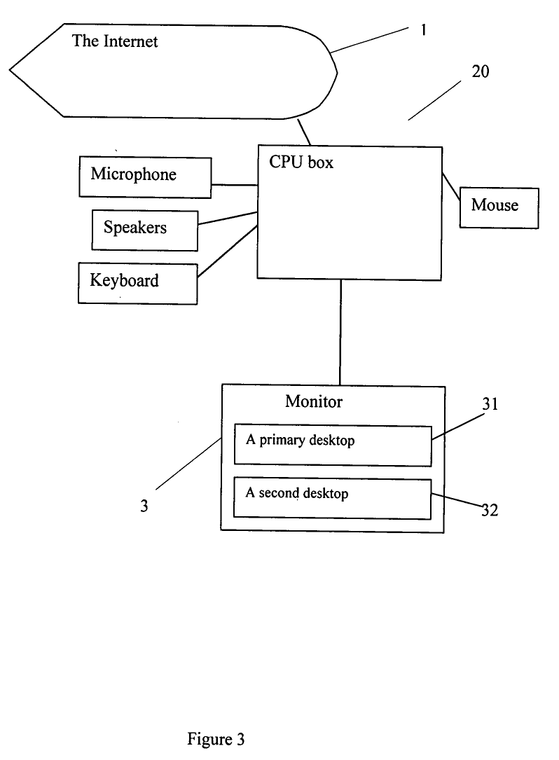

In FIG. 3 shows a typical computer 20 having two desktops. One is a primary desktop 31 which is created by its operating system in the conventional way; the other one 32 is a second desktop created by other software programs assissted by its operating system. A user can access the Interner 1 through the second desktop 32 which has low privileges and at the same time the primary desktop 31 has higer privileges. A user can use two different privilege desktops simultaneously. Having two different privilege desktops simultaneously provides easier usage and better protections.

To add more convenience, the second desktop 32 can have a different appearance, such as a different background color, from the primary desktop 31. This lets a user know which desktop he/she is in.

There are some ways to create a second desktop.

A remote desktop technology can be used to implement one user account having two desktops. A remote desktop is used as a second additional desktop.

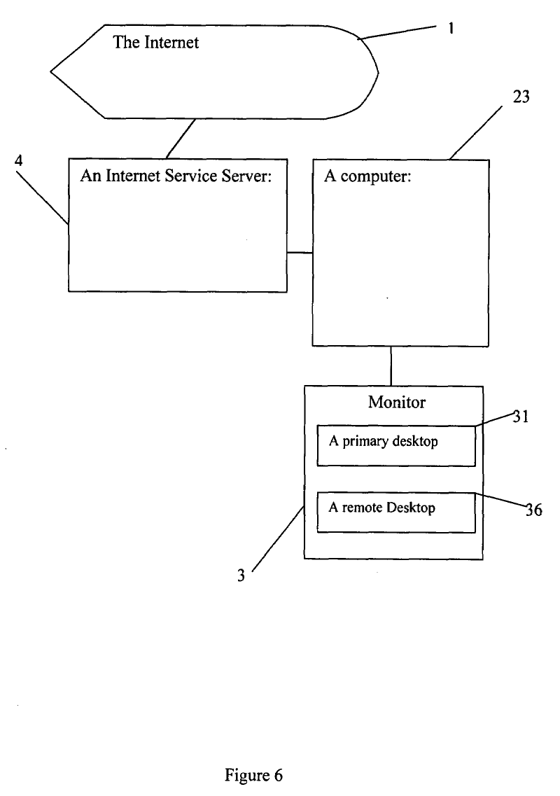

Remote desktop technologies have some advantages. One advantage is having a clickboard redirection feature. This feature lets these two desktops exchange data very easily. For example, in FIG. 6, some words in a textpad are selected and copied to the clickboard in the remote desktop 36, then they can be pasted into a Word file opened in the primary desktop 31.

Second advantage is that a remote desktop technology provides screen-edge switching whichmakes a user feel like he/she is using one desktop instead of two. A remote desktop can be resized, minimized, maximized and moved. It looks like just another application interface.

There are at least 3 ways of using a remote desktop technology to create a second desktop.

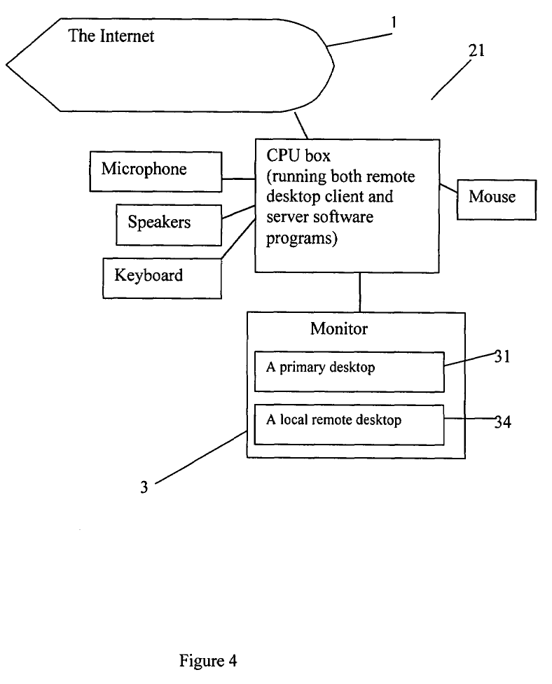

First way of using a remote desktop technology to create a second desktop is shown in FIG. 4. The computer 21 runs both a remote desktop client software program and a remote desktop server software program in itself.

When a user logged in into the computer 21 by using a high privileges account, the computer 21 will use a low privilege user account to launch the remote desktop client software, and the remote desktop client will connect to the local remote desktop server and produce the local remote desktop 34. The desktop 34 will be used to browser the Internet 1 and check emails.

The computer 21 also can run other software programs to assist the remote desktop client software to build the second desktop. For example, if a remote desktop technology is implemented within the Internet environment, such as Citrix's GoToMyPC, the computer 21 can have a web server and other software installed to imitate the Internet environment to implement a remote desktop.

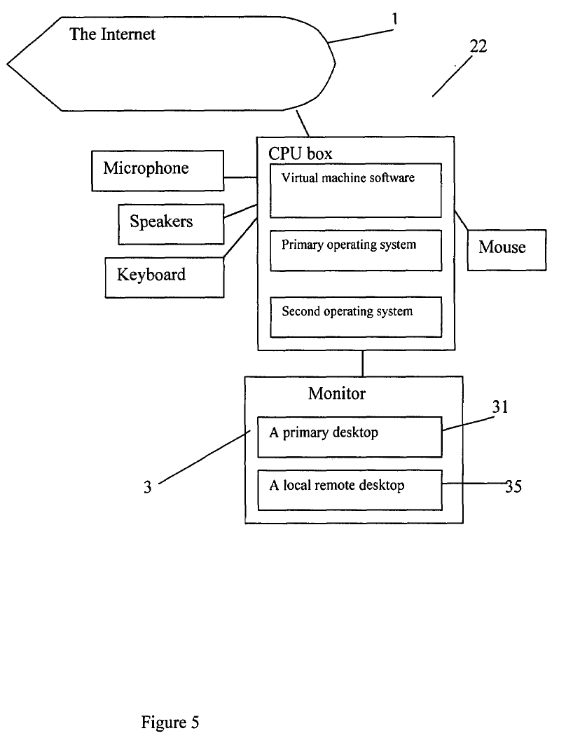

Second way of using a remote desktop technology to create a second desktop is shown in FIG. 5. This implementation also uses a virutal machine technology. In a computer 22, there are two operating systems running at the same time along with a virtual machine software program. One operating system is a primary operating system and has the remote desktop client software program installed and the other operating system is a second operating system and has the remote desktop server software program installed. The primary operating system will create two desktops, one is its own primary desktop 31 and the other is a local remote desktop 35 of the second operating system.

Above two ways, the first way and the second way of using a remote desktop technology to create a second desktop is suitable for only one computer being used, such as one personal computer, or one laptop. This implementation provides a self-protection solution for one computer.

Third way of using a remote desktop technology to create a second desktop is shown in FIG. 6. The creation is implemented through a network. A remote desktop server software program is installed in a computer 4, called an Internet Service Server. Another computer 23 has the remote desktop client software installed. These two computers 4 and 23 are connected by a network. The Internet Service Server 4 has connection to the Internet 1.

When a user logs in into the computer 23 with a high privileges user account, the computer 23 will use a low privileges user account to launch the remote desktop client software. The client software will connect with the remote desktop server software program installed in the Internet Servie Server 4, and create a remote desktop 36 of the Internet Service Server 4 on the computer 23's monitor 3. The remote desktop 36 will be used to handle potential risky tasks. The low privileges account used to build a remote desktop of the Internet Service Server 4 will provide certain protections for the Internet Service Server 4.

One advantage of this network implementation is that the computer 23 is isolated from the Internet 1. It is 100% secure from any internet viruses, worms, etc. The computer 23 doesn't need an Internet connection. The computer 23 only needs to connect to the Internet Service Server 4 and uses a remote desktop to access the Internet 1. Hence, the computer 23 is totally isolated from viruses, worms, etc.

If a remote desktop is implemented through the Internet, such as using VPN, GoToMyPC, the computer 23 can have highly restricted access to the Internet 1, or can only access certain trustworthy websites.

The computer 23 can have the Internet 1 access if it will use VOIP phone software, such as Skype, or other safe network-related software programs.

A shared storage area can be set up between the Internet Service Server 4 and the computer 23 for data exchanging. All files that are downloaded from the Internet 1 can be stored in a folder in the Internet Service Server 4 first. If a downloaded file needs to be opened in the computer 23, it will be examined before being moved to the shared folder.

This network implementation fits in with an existing regular computer system easily. A regular computer just needs to have some software installed, such as a remote desktop client software program to enjoy the benefit of the enhanced system.

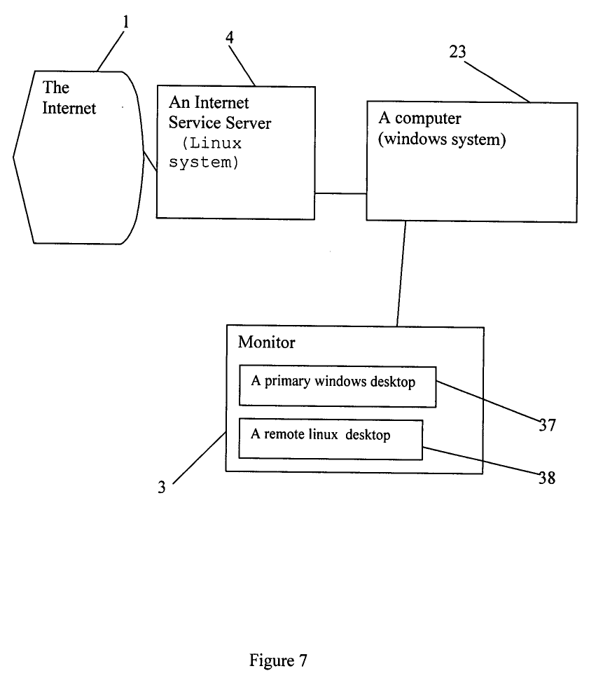

Another variation of this network implementation is shown in FIG. 7. There, the Internet Service Server 4 runs a different operating system from the computer 23. The Internet Service Server 4 runs a Linux system. The computer 23 runs a Windows system. On the computer 23, there are two desktops, one is remote Linux desktop 38; the other is primary windows desktop 37. Viruses which target Linux systems are rare. This will make this whole system more secure because no virus will attack more than one different operating systems.

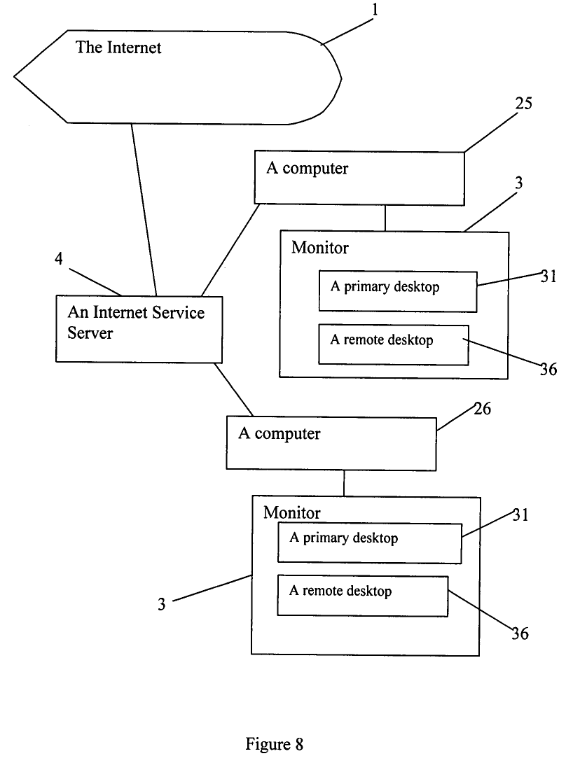

Another variation of the network implementation is shown in FIG. 8. There, one Internet Service Server 4 is serving two computers 25 and 26. Each computer 25 or 26 is assigned a session by the Internet Service Server 4. This is a good scheme for home networks or office environments where more computers are used.

Sometimes a remote desktop is referred to as a virtual desktop or a virtual terminal. A remote desktop server software program is referred as a remote terminal service.

There are several technologies which can be used to implement a remote desktop, such as the remote desktop provided in Windows XP; remote terminal service in Windows 2000 server; X windows in Linux; and Citrix's remote access; VPN (virtual private network), or VNC (virtual network computing), etc.

A computer or an Internet Service Server can be a Laptop, a Desktop, or a Handheld computer system.

The embodiments of the invention in which an exclusive: property or privelage is claimed are defined as follows:

1. A system of enhancing computer security comprising one computer having at least one monitor, an operating system and other peripherals and some software programs, said computer producing two desktops for a high privileges user account by adding a second additional desktop, one of said two desktops being given low privileges and being used to handle potential risky tasks.

2. A system as claimed in claim 1 said second additional desktop is created by running a software program having a graphic user interface which has some user interacting operation privileges.

3. A system as claimed in claim 1 said second additional desktop is created by producing an additional user account interface.

4. A system as claimed in claim 1 said computer evaluates the privilege of a user account which is being used to log in into said computer and produces said second additional desktop for high privileges user account automatically.

5. A system as claimed in claim 1 said computer creates said second additional desktop when a software program which is used to handle potential risky tasks is launched.

6. A system as claimed in claim 1 said computer creates said second additional desktop when a shortcut icon of a software program which is capable of creating a second desktop is executed.

7. A system as claimed in claim 1 said second additional desktop is created manually.

8. A system as claimed in claim 1 said computer running both a remote desktop server software program and a remote desktop client software program locally to produce a remote desktop as one of said two desktops.

9. A system as claimed in claim 1 said computer running a virtual machine software program and running two operating systems simultaneously, one is a primary operating system and the other is a second operating system, said computer also running a remote desktop server software program in said second operating system and a remote desktop client software program in said primary operating system; said computer produces a remote desktop of said second operating system as a second additional desktop for said primary operating system.

10. A system as claimed in claim 1 further comprising an Internet Service Server running a remote desktop server software program, said computer runs a remote desktop client software program and creates a second additional desktop by creating a remote desktop of said Internet Service Server.

11. A system claimed in claim 10 wherein said computer has no connection to the Internet.

12. A system claimed in claim 10 wherein said computer has restricted access to the Internet.

13. A system claimed in claim 10 wherein said Internet Service Server uses a different operating system from said computer.

14. A system claimed in claim 10 wherein said Internet Service Server is capable of serving more than one said computer simultaneously.

15. A method of enhancing computer security comprising logging in into a computer being capable of creating two different privileges desktops for high privileges user accounts on its monitor, using one desktop being assigned low privileges to perform potential risky, network-related tasks.
